(19) United States
(12) Patent Application Publication
(10) Pub. No.: US 2015/0296598 A1
(43) Pub. Date: Oct. 15, 2015

(54) Contactless Device Configuration

(71) Applicant: Infineon Technologies AG, Neubiberg (DE)

(72) Inventors: Josef Haid, Graz (AT); Sergio Rossi, Genoa (IT); Kurt Marquardt, Muenchen (DE)

(21) Appl. No.: 14/671,592

(22) Filed: Mar. 27, 2015

Related U.S. Application Data
(60) Provisional application No. 61/978,633, filed on Apr. 11, 2014.

(51) Int. Cl. H05B 37/02; H05B 33/08

(52) U.S. Cl. CPC H05B 37/0272; H05B 33/0884; H05B 33/0845; H05B 33/0857

(57) ABSTRACT

A driver for a lighting product includes a wireless interface circuit configured to be accessed wirelessly to store information relating to operation of the lighting product. A driving circuit is coupled to the wireless interface circuit. The driving circuit is configured to retrieve the stored information relating to the operation of the lighting product from the wireless interface circuit and drive the lighting product based on the retrieved information.

This application claims the benefit of U.S. Provisional Application No. 61/978,633, filed on Apr. 11, 2014, which application is hereby incorporated herein by reference.

### TECHNICAL FIELD

The present invention relates generally to lighting products, and, in particular embodiments, to a system and method for contactless device configuration of lighting products.

### BACKGROUND

Radio-frequency identification (RFID) is the wireless non-contact use of radio-frequency electromagnetic fields to transfer data. RFID operates at a range of radio frequencies each with their own set standards and protocols. A radio-frequency identification system uses tags, or labels attached to the objects to be identified. Two-way radio transmitter-receivers called interrogators or readers send a signal to the tag and read its response.

RFID tags can be either passive, active, or battery-assisted passive. An active tag has an on-board battery and periodically transmits its ID signal. A battery-assisted passive (BAP) has a small battery on board and is activated when in the presence of an RFID reader. A passive tag is cheaper and smaller because it has no battery. Tags may either be read-only, having a factory-assigned serial number that is used as a key into a database, or may be read/write, where object-specific data can be written into the tag by the system user. Near field communication (NFC) operates at 13.56 MHz and is an extension of High Frequency (HF) RFID standards. NFC therefore shares many physical properties with RFID such as one way communication and the ability to communicate without a direct line of sight. There are however some key differences. NFC is capable of two way communication and can therefore be used for more complex interactions such as card emulation and peer-to-peer (P2P) sharing.

NFC also involves a reader (or initiator) and a target. The reader actively generates a RF field that can power a passive target or a tag. This enables NFC tags to be configured so as to have very simple form factors that do not require batteries.

### SUMMARY

In accordance with an embodiment of the present invention, a driver for a lighting product includes a wireless interface circuit configured to be accessed wirelessly to store information relating to operation of the lighting product. A driving circuit is coupled to the wireless interface circuit. The driving circuit is configured to retrieve the stored information relating to the operation of the lighting product from the wireless interface circuit and drive the lighting product based on the retrieved information.

In accordance with an alternative embodiment of the present invention, a method of configuring an electronic controller (EC) includes wirelessly receiving wireless signals comprising information relating to operation of an EC from a wireless control device to a wireless interface circuit and processing the wireless signals to retrieve the information relating to the operation of the EC. The method further includes storing the information relating to the operation of the EC at the wireless interface circuit.

In accordance with an alternative embodiment of the present invention, a method of manufacturing an electronic product line comprises packaging a plurality of semiconductor devices to form a plurality of identical electronic products. Each of the plurality of identical electronic products is configured to have similar input/output characteristic such that each of the plurality of identical electronic products is configured to operate with a first characteristic. The method further includes wirelessly configuring a first set of the plurality of identical electronic products to generate a plurality of electronic products having a second characteristic different from the preconfigured first characteristic. Each of the plurality of electronic products is configured to operate with the second characteristic during operation.

In accordance with an embodiment of the present invention, a lighting electronic controller (EC) circuit comprises a radio frequency (RF) antenna configured to receive RF signals comprising information relating to an operation of an EC. A RF front end is configured to process the RF signals received at the antenna and retrieve the information relating to the operation of the EC. A non-volatile memory is configured to store the information relating to the operation of the EC. A power generator is configured to generate power wirelessly and provide power supply to the RF front end and the non-volatile memory.

### BRIEF DESCRIPTION OF THE DRAWINGS

For a more complete understanding of the present invention, and the advantages thereof, reference is now made to the following descriptions taken in conjunction with the accompanying drawings, in which:

FIG. 1 illustrates a wireless communication system for configuring a device in accordance with an embodiment of the present invention;

FIG. 2A illustrates a schematic of the wireless communication circuit in accordance with an embodiment of the present invention;

FIG. 2B illustrates a schematic block diagram of an ECU device in accordance with an embodiment of the present invention.

FIGS. 3A-3C illustrate a more detailed schematic of the luminaire device in accordance with various embodiments of the present invention, wherein FIG. 3A illustrates one example of an ECU device comprising a switched mode power supply unit, for example, comprising a buck converter for supplying power to a lamp using embodiments of the present invention, wherein FIG. 3B illustrates another example of an ECU device comprising a switched mode power supply unit, for example, comprising an isolated flyback topology for supplying power to a lamp using embodiments of the present invention, and wherein FIG. 3C illustrates the internal circuitry of a digital platform controller in FIG. 3B in accordance with an embodiment of the present invention;

FIGS. 4A-4B illustrate a schematic of operations of a wireless communication system in accordance with an embodiment of the present invention;

FIGS. 5A-5D illustrate the process flow of configuring a luminaire device in accordance with an embodiment of the present invention and FIG. 5D schematically illustrates the configuration of a plurality of luminaire devices in accordance with embodiment of the present invention;

FIGS. 6A-6C illustrate a luminaire unit in accordance with an alternative embodiment of the present invention, wherein FIG. 6A illustrate a schematic of the luminaire unit while FIGS. 6B and 6C illustrate alternative embodiments of the wireless interface circuit;

FIGS. 7A and 7B illustrate an embodiment of the present invention for configuring the operation of an ECU, wherein FIG. 7A illustrates a lamp comprising a plurality of LEDs operating at multiple output wavelengths, wherein FIG. 7B illustrates another embodiment in which one or more LED devices has a phosphor coating resulting in dual emission; and

FIG. 8 illustrates a luminaire device outputting multiple currents in accordance with embodiments of the present invention.

### DETAILED DESCRIPTION OF ILLUSTRATIVE EMBODIMENTS

Producers of various electronics products such as lighting products are tasked to produce a large number of products with slightly varying functionality. Conventionally, to meet this demand, producers of such electronic products produce and stock a large variety of similar products. This results in large inventory build-up, logistic costs, and others.

In order to reduce the variety of lighting products, producers wish to produce and stock a single part number at the producer's warehouse, and program a specific functionality when shipping the part to a specific end customer from the warehouse. For such applications, the variations in the functionality may be obtained by varying the operation of the lighting product. However, conventional approaches do not allow any configuration once the product is moved from the production line to the warehouse. Configuring the lighting products using a hard cable connection requires access to the device I/O terminals. However, many lighting products are sealed in a plastic box rendering such options moot. Alternatively, having exposed I/O terminals results in poor weather proofing of the lighting products. Therefore a large number of different products need to be manufactured and stocked at the warehouse. This causes logistic challenges and additional costs.

Various embodiments of the present invention enable reduction in costs by simplifying the process for activation and/or configuration of electronic devices. Embodiments of the present invention use the capability of communicating and powering devices through a wireless medium such as a radio frequency field.

Although there is no galvanic or other physical access to ECU of these electronic products after packaging the devices, embodiments of the present use wireless operations to power the storage and transfer parameters within the lighting products. Thus, using embodiments of the invention, all packaging operations may be performed before the configuration of the product so that a single product is stored in the warehouse. After packaging, a memory of the electronic product is written into wirelessly, for example, using near field communication protocol or one of a radio frequency identification protocol.

Embodiments of the present invention may use mobile devices, scanners, and other devices, which include a contactless reader device, to power a device, e.g., a chip card and/or an RFID tag (Radio Frequency Identification tag), and a secondary device through the RF-field, where the power emitted by the contactless readers may be used to power the secondary device for the purpose of activation and configuration, and further for performing standard operations such as controlling a task on the secondary device via commands. The communication required to perform this task may be provided by the reader device as well as the target device.

Embodiments of the present invention provide an arrangement for activation and/or configuration of a target device, wherein no connection or unpacking may be required by the target device to perform configuration and activation. For example, configuration, communication, data processing, and/or storage in the target device may be carried out without the need for a power supply attached to the electronic device. Power needed for operation may be provided by a contactless reader device emitting an RF-field. The communication between the reader and the extension of the electronic device may be performed by both devices.

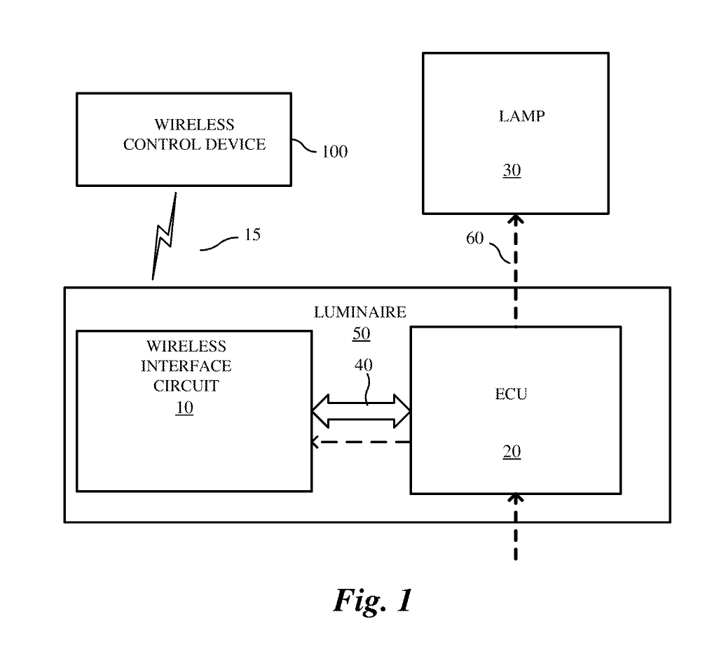

FIG. 1 illustrates a wireless communication system for configuring a device in accordance with an embodiment of the present invention.

The system includes a lamp 30 and a lamp housing or luminaire 50, which includes a wireless interface circuit 10 and an electronic control unit (ECU) device 20 for powering the lamp 30. As further described in various embodiments of the present invention, the ECU device 20 is implemented in hardware, although it may include software, and may be an electronic controller. For example, in one embodiment, the lamp 30 is a light emitting diode (LED).

In various embodiments, the ECU device 20 may include a power supply unit such as a switched mode power supply. The ECU device 20 may include a digital integrated circuit controller with one or more drivers for external switches along with one or more inductors. The ECU device 20 may be an isolated or a non-isolated type in various embodiments.

In various embodiments, the ECU device 20 may be configured to provide a constant voltage and/or constant current to the lamp 30. In one embodiment, the ECU device 20 provides a DC voltage at a constant current to the lamp 30. For example, the light output from LEDs varies with the current and therefore providing a constant current is important. Therefore, LEDs require a device that can convert incoming AC power to the proper DC voltage, and regulate the current flowing through the LED during operation. For example, the ECU device 20 converts 120V (or other voltage) AC power to low-voltage DC power required by the LEDs. The ECU device 20 may also include protection devices, for example, to protect the LEDs from line-voltage fluctuations or too high operating temperatures.

Referring again to FIG. 1, the wireless interface circuit 10 communicates with the wireless control device 100, which is a programming device, through a wireless channel 15. In one or more embodiments, the wireless communication may be performed using radio frequency electromagnetic waves. However, in other embodiments, the wireless communication may be through other frequencies such as optical waves or other types of carriers such as sound, magnetic induction. In various embodiments, the wireless control device 100 communicates with the wireless interface circuit 10 according to a RFID protocol or a near field communication (NFC) protocol.

In one or more embodiments, the wireless control device 100 is configured to include a transmitter for communication with the wireless interface circuit 10. The wireless control device 100 may include a two way radio transmitter-receiver to send information to the wireless interface circuit 10 and also receive a response in some cases. In one or more embodiments, the wireless control device 100 includes at least a transmitter for sending information to the wireless interface circuit 10.

In various embodiments, the wireless control device 100 may be included within a mobile phone, a tablet, a laptop, or other smart devices. The wireless control device 100 may be accessed through an application or program running on the mobile phone, the tablet, the laptop, or the other smart devices.

In various embodiments, the wireless interface circuit 10 comprises an antenna for communication. The wireless interface circuit 10 may be an active or a passive circuit in various embodiments. A passive wireless interface circuit 10 does not require an external wired power source for operation. In case the wireless interface circuit 10 is passive, power required for communicating, processing, and storing information may be obtained from the wireless control device 100.

In various embodiments, the wireless control device 100 is configured to send one or more parameters relating to the operation of the lamp 30 to the wireless interface circuit 10. The parameter relating to the operation of the lamp 30 may include operating current, operating voltage, or ranges of the same.

In one or more embodiments, the lamp 30 is a light emitting diode (LED). In such an embodiment, the parameters relating to the operation of the lamp 30 may include parameters to determine the LED driving current, which controls the brightness of the LED. In further embodiments, the parameters may be used to turn off or used to configure protection circuits such as over-current protection, over temperature protection, and/or under voltage protection.

In one or more embodiments, the parameters may be used to adapt certain physical parameters of external devices such as transformers or capacitors. In further embodiments, the parameters may be used to activate or deactivate custom circuits, functions, and/or features.

Embodiments of the present invention also include parameters, which may require further processing at the ECU device 20. For example, the parameter may include color temperature, luminosity, for example, brightness as a function of wavelength. For example, in one or more embodiments, the parameter may determine a correlated color temperature (CCT) range or a particular CCT for the light output. For example, soft white light comprises a CCT of about 2700K-3000K, while bright white/cool white light comprises a CCT of between about 3500K-4100K, and daylight is about 5000K-6500K. The ECU device 20 can use this information to differentially bias LEDs of different colors so as to obtain a specific spectral function.

In other examples, the parameters may include recordation of operating conditions such as error conditions, debugging data; operating criterion including operating hours, operating life time; geographic data; user authorization data; user preferences; and others.

Embodiments of the present invention also envision the use of these parameters using a control loop. For example, the color temperature stored in the parameter may be accessed during operation and the drive current of the LEDs may be compensated to match the stored color.

The wireless interface circuit 10 stores the parameter relating to the operation of the lamp 30, which may be retrieved by the ECU device 20 during subsequent operation of the lamp 30.

As illustrated in FIG. 1, the wireless interface circuit 10 may be coupled to the ECU device 20 through a bus 40, which may be a digital bus in one or more embodiments. The ECU device 20 may be configured to read the parameter relating to the operation of the lamp 30 from the wireless interface circuit 10.

The ECU device 20 uses the parameter relating to the operation of the lamp 30 and adjusts the output 60 of the ECU device 20 and/or takes other actions based on the parameter relating to the operation of the lamp 30. The power input into the ECU device 20 and the power output 60 from the ECU device 20 to the lamp 30 and optionally to the wireless interface circuit 10 is illustrated with dashed lines.

In various embodiments, the wireless interface circuit 10, the wireless control device 100, and the ECU device 20 may include one or more circuit elements including one or more semiconductor chips. In some embodiments, the wireless interface circuit 10 and the ECU device 20 may be integrated into a single chip.

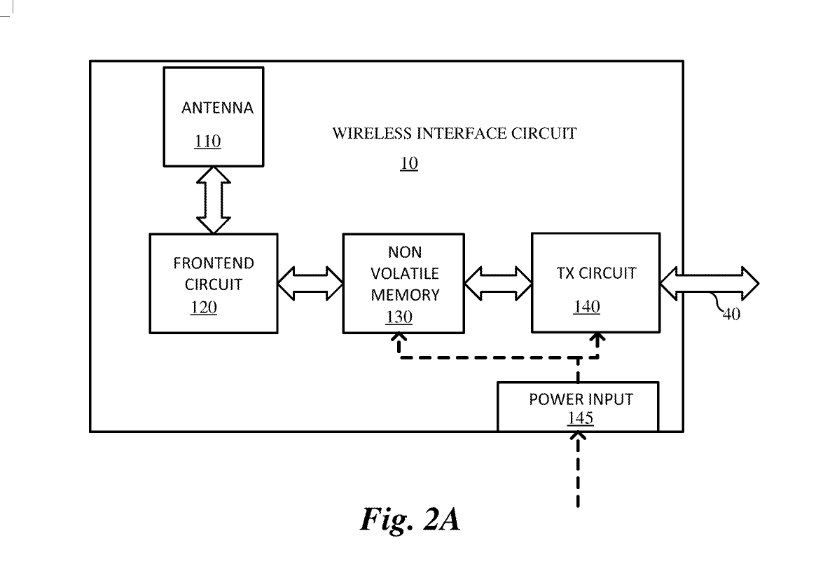

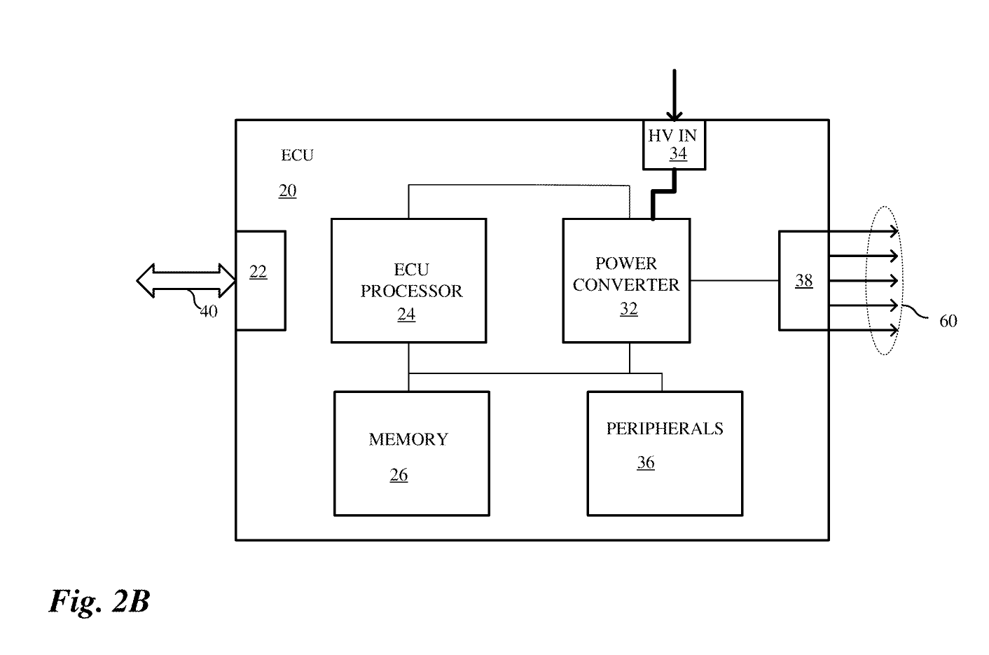

FIG. 2A illustrates a schematic of the wireless communication module in accordance with an embodiment of the present invention.

Referring to FIG. 2A, the wireless interface circuit 10 includes an antenna 110 to receive and/or transmit wireless communication to and from the wireless control device 100, and power from the control device which is shown in FIG. 1. The signals received at the antenna 110 are processed at a frontend circuit 120 to retrieve the information or parameters relating to the operation of the lamp 30 and the power to operate the wireless interface circuit.

The frontend circuit 120 may be an integrated circuit for storing and processing information, modulating and demodulating a radio-frequency (RF) signal. The frontend circuit 120 may also collect DC power from the wireless control device 100. The antenna 110 may be integrated with the frontend circuit 120 in a single chip in some embodiments. Although not illustrated, in some embodiments, the wireless interface circuit 10 may also include a dedicated processor.

The retrieved information or parameters relating to the operation of the lamp 30 is stored in a non-volatile memory 130. In various embodiments, the non-volatile memory 130 may include a flash memory, an EEPROM, an OTP memory, and other non-volatile memories.

In various embodiments, the antenna 110 and the frontend circuit 120 may be configured for near field communication technology and/or RFID technology. Standards for near field communication technology may include ISO/IEC 18000, IS O/IEC 18092, ISO/IEC 14443, IS O/IEC 15693, IS O/IEC 21481, NFC Forum specifications. For example, the antenna 110 may be configured to receive signals using near field communication protocol. The antenna 110 may be configured to receive the signals via magnetic induction and may include one or more loop antenna.

In alternative embodiments, the wireless interface circuit 10 may be compatible with other lower power technologies such as IEEE 802.15.4, ZigBee which is based on IEEE 802.15.4, Radio Frequency for Consumer Electronics (RF4CE) which is based on ZigBee, ANT protocol, ultra-wide band (e.g., >500 MHz), 6LoWPAN (IPv6 over Low power Wireless Personal Area Networks). Embodiments of the present invention may also use Bluetooth, BTLE, Dash 7, or other Sub 1 GHz standards. The wireless interface circuit 10 may further include an optional transmitter circuit 140 that is powered through the power input interface 145 when the ECU device 20 is powered. In contrast, the antenna 110, the frontend circuit 120, and/or the non-volatile memory 130 may be active or passive devices. Accordingly, the wireless interface circuit 10 may be written into without additional power besides the power from the wireless control device 100. However, some power may be provided while retrieving the stored information.

The wireless interface circuit 10 is coupled to the ECU device 20 through a bus 40. Accordingly, the wireless interface circuit 10 and the ECU device 20 may include corresponding communication interfaces for communicating through the bus 40. Examples of the communication interface include inter-integrated circuit interface (12C), serial peripheral interface (SPI), universal asynchronous synchronous interface (UART), USB, Single wire Interface, Ethernet interface.

FIG. 2B illustrates a schematic block diagram of a luminaire device in accordance with an embodiment of the present invention.

Referring to FIG. 2B, the ECU device 20 may include an input interface 22 coupled to the bus 40, an ECU processor 24, a memory 26, a power input 28 for supplying power to the various components, a HV pin 34 for the high voltage input used by the power converter 32. The ECU processor 24 may provide the processing functionality for ECU device 20 while the memory 26 may be used to store information during processing and/or after powering down.

The power converter 32 may take inputs from the ECU processor 24 and convert the high voltage power at the HV pin 34 to an appropriate power supply suitable for the lamp 30. The power output pin 38 may be coupled to the lamp 30 through the output 60, which may provide the operating power to the lamp 30. In some embodiments, the power output pin 38 may include a plurality of output lines so that a plurality of independent units of the lamp 30 may be configured simultaneously although typically the power output pin 38 is coupled to a power transistor, which establishes the power supply to the lamp 30. For example, a plurality of LEDs at the lamp 30 may be controlled by the ECU device 20.

The ECU device 20 may also include peripherals 36 used for auxiliaries operations, for example, sensors for sensing and monitoring the operation of the lamp 30 or the whole system, user input pins, serial interfaces, and others. In one or more embodiments, peripherals 36 may comprise protection circuits and devices. In one or more embodiments, the protection devices can be integrated and may be part of the same chip or alternatively may be implemented using software. In various embodiments, the peripherals 36 may include one or more protection devices. For example, the protection device may be an over-voltage protection device configured to prevent voltage spikes from damaging the ECU device 20 or the lamp 30. Similarly, the protection device may be an over-current protection device. In another embodiment, the protection device may be an under-voltage protection device, e.g., to turn off the circuits in the ECU device 20 or the lamp 30 if the voltage drops below a specific threshold. Similarly, the protection device may be a thermal protection device.

The ECU processor 24 obtains the information or parameters relating to the operation of the lamp 30 stored in the non-volatile memory 130 of the wireless interface circuit 10. This information may be stored in the memory 26 for subsequent use. For example, in some embodiments, the information or parameters relating to the operation of the lamp 30 may be retrieved once during initial set up of the lamp 30 by the end customer.

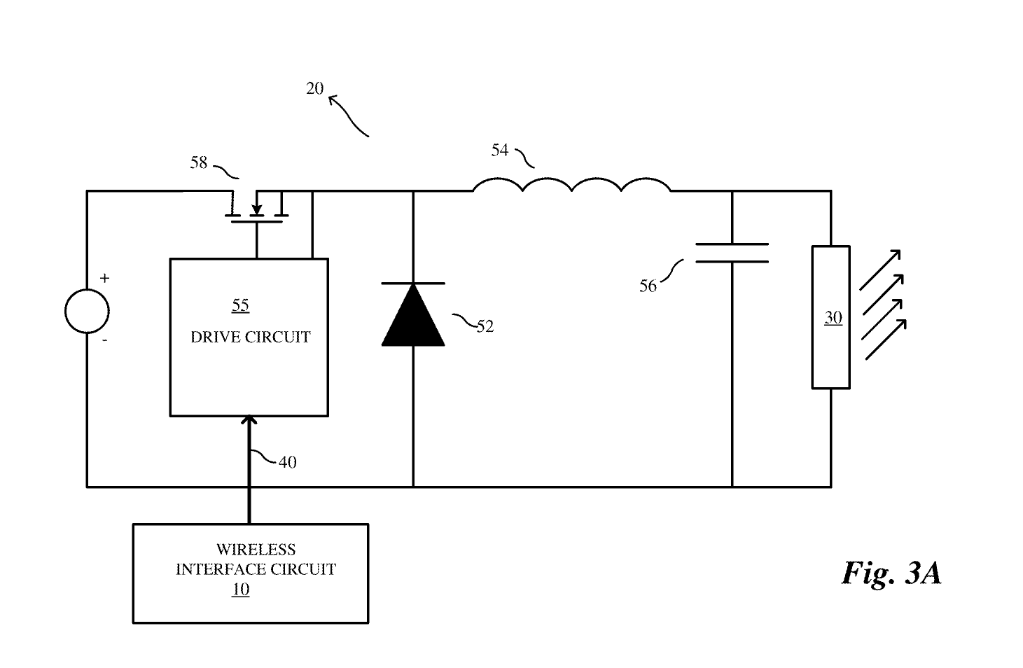

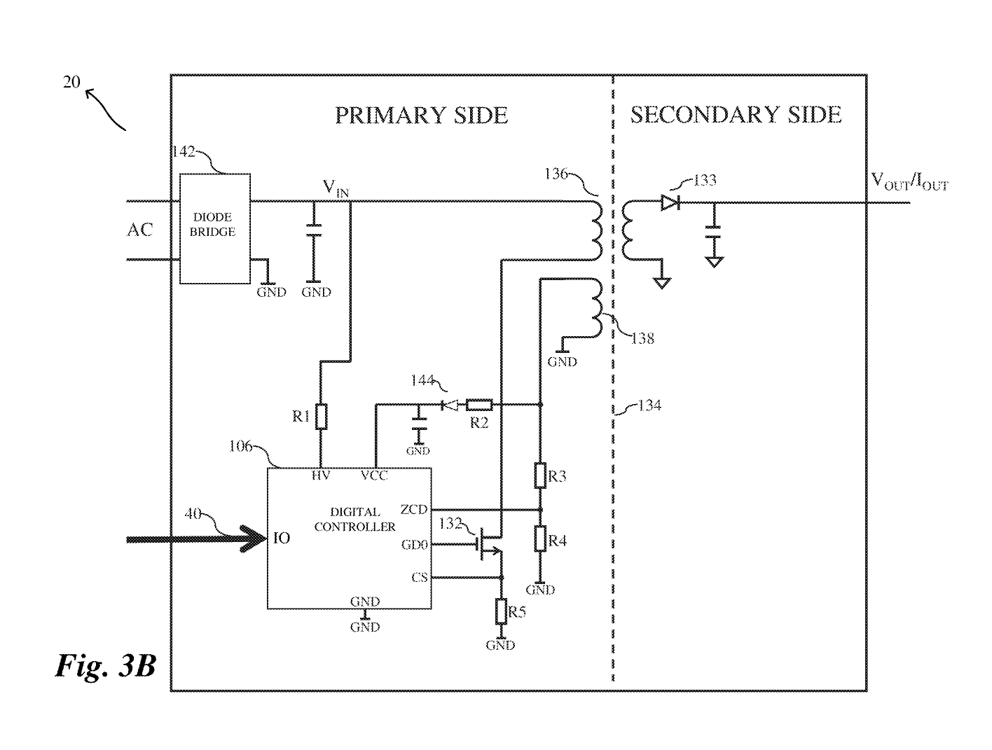

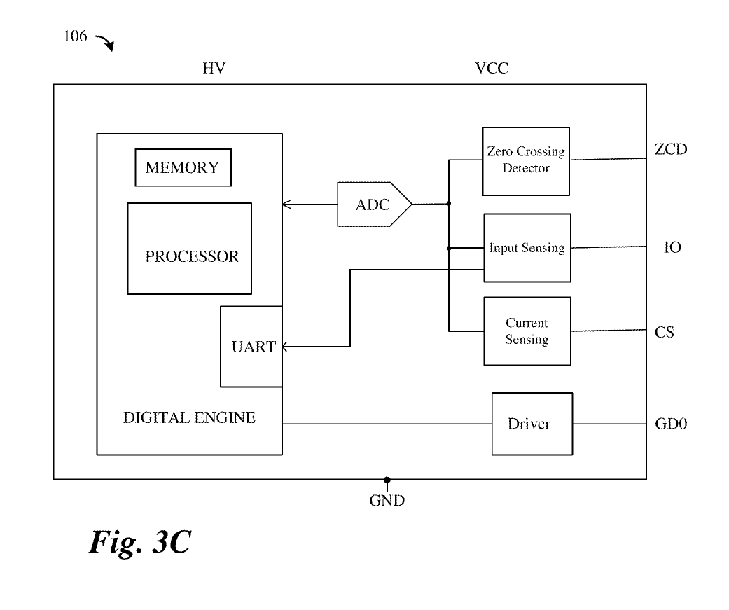

FIG. 3A illustrates a more detailed schematic of the ECU device in accordance with various embodiments of the present invention.

In various embodiments, the ECU device may include different types of power supply configurations depending on the type of the lamp 30 being powered. For example, in one or more embodiments, the lamp 30 may be a light emitting diode (LED), a fluorescent lamp, and others.

In various embodiments, the ECU device circuitry may be adjusted depending on the specification of the lamp 30. In one or more embodiments, the operation of the lamp 30 is controlled prior to operation based on the information obtained from the wireless interface circuit 10.

In various embodiments, the voltage management circuitry of the ECU device 20 may be selected based on the rating of the lamp 30 and may use an isolated topology such as a full bridge, half bridge, a forward, a flyback, or a push-pull topology or non-isolated topology such as a buck converter, a buck-boost converter, a resonant topology, or a linear regulator.

FIG. 3A illustrates one example of an ECU device comprising a switched mode power supply unit, for example, comprising a buck converter for supplying power to a lamp using embodiments of the present invention.

The buck power stage with a drive circuit block is illustrated in FIG. 3A. The power switch 58 may be an n-channel MOSFET. The buck converter includes the diode 52 usually called the freewheeling diode. The inductor 54 and capacitor 56 make up an output filter. The output of the buck is coupled to a load (lamp 30), which emits lights. The drive circuit 55 controls the power switch 58 thereby controlling the current through the inductor 54. As described earlier, the wireless interface circuit 10 is coupled to the drive circuit 55 through bus 40. The drive circuit 55 may obtain operating parameters for driving the power switch 58 from a memory of the wireless interface circuit 10. The drive circuit 55 may include a memory where the retrieved information is stored. After retrieving the operational parameters from the wireless interface circuit 10, the drive circuit 55 drives the power switch 58 based upon it. Thus, the output voltage of the buck converter is modulated by the information from the wireless interface circuit 10.

FIG. 3B illustrates another example of an ECU device comprising a switched mode power supply unit, for example, comprising an isolated flyback topology for supplying power to a lamp using embodiments of the present invention.

FIG. 3C illustrates the principle block diagram of the digital controller in FIG. 3B using embodiments of the present invention.

In another illustration, the power supply comprises a switched mode power supply unit, for example, a flyback transformer 136 that provides a desired operating current (I_{OUT}) and voltage (V_{OUT}) to the lamp 30. The power supply is controlled by a controller 106 (digital controller), which takes input from the wireless interface circuit 10.

Referring to FIG. 3B, the input AC voltage is converted through a diode bridge 142 or rectifier into a DC supply voltage V_{IN}, which is provided to the high side of the primary winding of a flyback transformer 136. The flyback transformer 136 includes a winding on the primary side and a winding on the secondary side, which are separated by the isolation 134. Additionally, the flyback transformer 136 may include an auxiliary winding 138.

The supply voltage V_{IN} is also provided to the controller 106 into the high side voltage (HV) pin. The controller 106 further includes a constant current supply voltage pin VCC, which is coupled to the auxiliary winding 138 through a blocking diode 144 and a resistor R2.

As illustrated in FIG. 3C, the controller 106 may include a digital engine, which among other things may include a memory and a processor. In some embodiments, the components of the controller 106 may be integrated at different levels, for example, on a same board, different board, same package, different package, same chip, different chips, and others. For example, in one case, the A/D Converter may be integrated with the digital engine on a single chip. In another example, the processor and the memory may be integrated on a single chip. In other embodiments, the processor, memory, and other components may be less integrated and may also include analog components as well as discrete devices.

Referring to FIGS. 3B and 3C, the controller 106 includes an input output (TO) pin capable of receiving command signal from the wireless interface circuit 10. In one illustrative embodiment, the input output pin is a MFIO pin that is used for many types of input. For example, the MFIO pin can be configured to sense the input for an A/D converter, e.g., an 8-bit A/D converter, and/or sense the input for the UART of a digital engine as examples. The digital engine may also include other circuitry for other types of inputs.

As described previously, the wireless interface circuit 10 may include a transmitter circuit 140 for generating a digital signal through the digital bus 40. For example, the transmitter circuit 140 at the wireless interface circuit 10 may read the contents of the non-volatile memory 130 and generate a UART signal in one embodiment. This UART signal is then transmitted to the controller 106 of the ECU device 20 through the digital bus 40. The IO pin at the controller 106 receives this digital signal and is passed on to a UART at the digital engine of the controller 106. The digital signal may indicate the information or parameters relating to the operation of the lamp 30 in one embodiment.

The primary controller 106 obtains the information or parameters relating to the operation of the lamp 30 stored in the non-volatile memory 130 of the wireless interface circuit 10. This information may be subsequently stored in the memory of the controller 106. The controller 106 appropriately uses the information or parameters relating to the operation of the lamp 30. For example, if the information or parameters relating to the operation of the lamp 30 includes an operating current, then the controller 106 adjusts the output current I_{OUT} from the power supply. The controller 106 may drive the switch 132 to produce the desired output. A feedback network (R3, R4, and R5) may be used to regulate the output voltage or current.

Accordingly, in one or more embodiments, the digital engine of the controller 106 uses the information in the digital signal to control the switch 132. For example, this may be accomplished through pulse width modulation (PWM) by applying a PWM signal to the gate of the switch 132 through the gate driver pin.

In alternative embodiments, the controller 103 uses the information stored in the wireless interface memory to change other parameters of the operation. For example, the controller 103 may store the operating conditions of the lamp 30 in an internal or external memory.

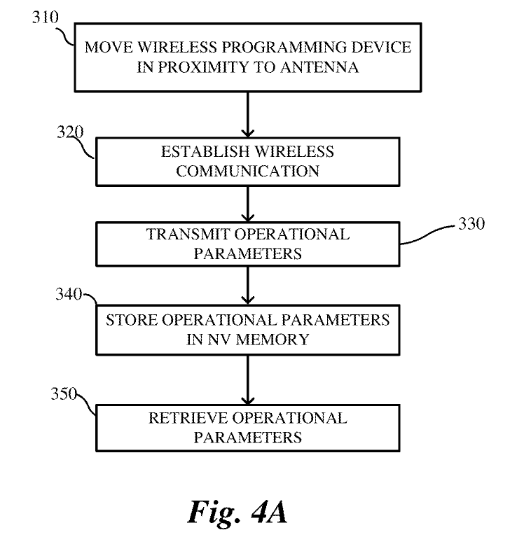

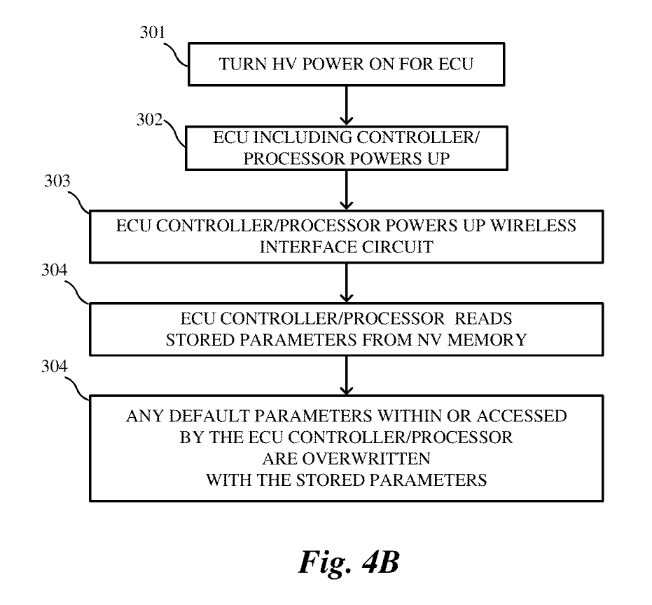

FIG. 4A illustrates a schematic of operations for programming a lighting product in accordance with an embodiment of the present invention. FIG. 4B illustrates a schematic of operations during normal use of the lighting product in accordance with an embodiment of the present invention.

FIGS. 4A and 4B will be described using FIGS. 1 and 2 for ease of understanding. Referring to FIG. 4A, the wireless interface circuit 10 and wireless control device 100 is brought within the communication range of each other (box 310). The communication range may depend on the communication protocol being used. For example, near field protocols (NFCs) may need a distance of 5 cm or less while other RFID protocol may work within a much larger distance.

As next illustrated in box 320, a wireless communication is established between the wireless interface circuit 10 and wireless control device 100. The wireless interface circuit 10 may also generate power to operate from the electromagnetic field generated by the wireless control device 100.

Next, the wireless control device 100 transmits the operational parameters (box 330). The antenna 110 of the wireless interface circuit 10 receives the transmitted signals, which is processed at the frontend circuit 120 to generate information or parameters relating to the operation of the lamp 30.

The information or parameters relating to the operation of the lamp 30 are stored in the non-volatile memory 130 (box 340). Subsequently, during or prior to operation of the lamp 30, these information or parameters relating to the operation of the lamp 30 are retrieved from the non-volatile memory 130 (box 350). The ECU device 20 uses the retrieved information to configure the output to the lamp 30.

Referring to FIG. 4B, in one or more embodiments, the high voltage (HV) power is turned on for the ECU device 20 (box 301). This leads to the powering up of the ECU controller/processor (e.g., ECU processor 24) as well as other components of the ECU device 20 (box 302). Next, as illustrated in box 303, the ECU controller/processor 24 powers up the wireless interface circuit 10. Referring next to box 304, the ECU controller/processor 24 reads the stored (previously programmed) parameters from the nonvolatile memory such as the non-volatile memory 130 within the wireless interface circuit 10. Any default parameters within or previously accessed by the ECU controller/processor are overwritten with the stored parameters, and subsequently used instead of the default parameters. Accordingly, the lamp unit operates with the stored parameters instead of the default parameters.

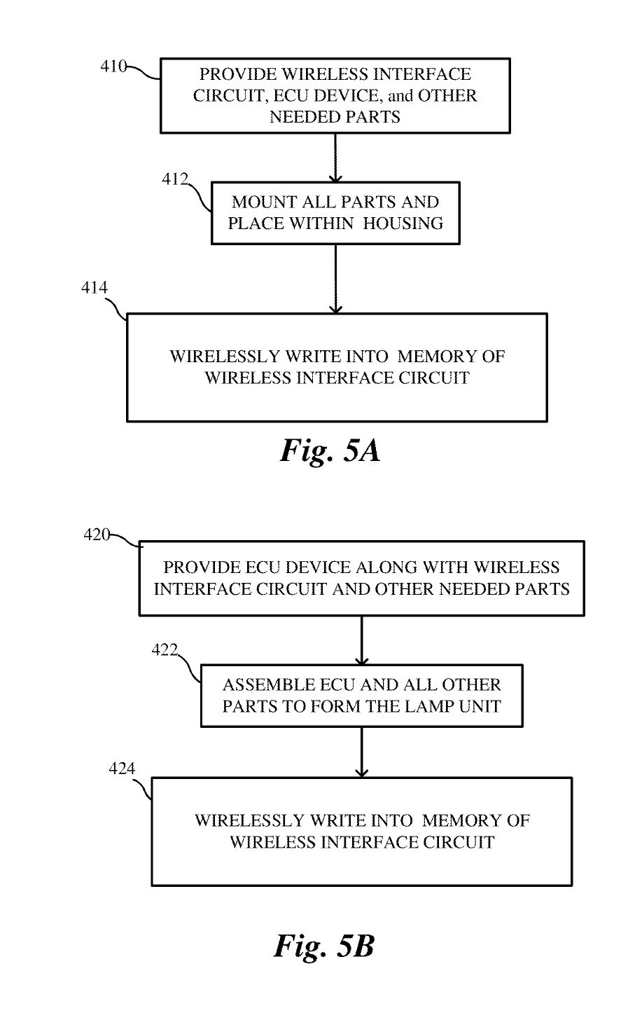

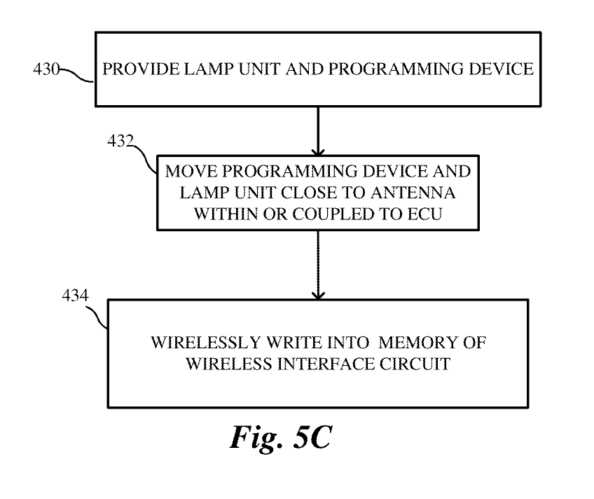

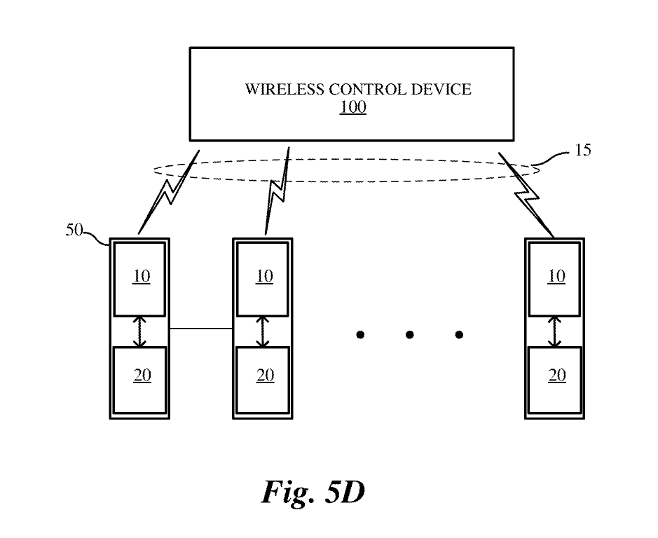

FIGS. 5A-5C illustrate process flows for configuring an ECU device in accordance with embodiments of the present invention. FIG. 5D schematically illustrates the configuration of a plurality of ECU devices in accordance with embodiment of the present invention.

In various embodiments, the programming operations may be performed at one or more stages of manufacturing/assembling the lighting product. Typically, a lighting product is manufactured and assembled at different factories although some device manufacturers may integrate one or more of the operations at a single facility.

FIG. 5A illustrates operations for configuring an ECU device by a ECU device manufacturer, FIG. 5B illustrates operations for configuring an ECU device at the maker of the lighting product, while FIG. 5C illustrates operations for configuring an ECU device by an installer of the lighting product.

FIGS. 5A-5C will be described relative to the drawings previously illustrated, for example, in FIG. 1. Referring to FIG. 5A, the wireless interface circuit 10, the components of the ECU device 20, and other needed parts are fabricated and provided (box 410). Next, the devices including the wireless interface circuit 10, ECU processor 24 and power converter 32 are mounted on a printed circuit board and placed within the housing of a luminaire 50 (box 412). After the packaging, there is no physical access, i.e., electrical input/output connector, to the wireless interface circuit 10 or the ECU device 20. Thus, using embodiments of the invention, all manufacturing related operations may be performed before the configuration of the ECU device 20. Referring to box 414, after packaging, the memory of the wireless interface circuit 10 is written into wirelessly, for example, using near field communication protocol or one of a radio frequency identification protocol.

Referring to FIG. 5B, in case of the lamp maker, who obtains an ECU with the wireless interface circuit (box 420). The lamp maker assembles the ECU along with all other components to form a lamp unit (box 422). In one embodiment, the ECU may not have been previously programmed. In another embodiment, the ECU is previously programmed by the manufacturer of the ECU. The lamp maker has the option to program the ECU during or after assembly so that a lamp having suitable characteristics may be shipped to their customers. In such instances, the lamp maker may wirelessly write into the nonvolatile memory of the wireless interface circuit.

Referring to FIG. 5C, in some embodiments, the installer of the lamp may also program the lighting product during installation. The installer obtains a lighting product (box 430). The installer also obtains the programming device from the maker of the lighting product or obtains software such as an App from the maker of the lighting product. Alternatively, the installer may configure a generic software application to program the lighting products. The installer then brings the programming device in close proximity with an antenna within or coupled to the ECU device (box 432). The installer may then wirelessly write into the nonvolatile memory of the wireless interface circuit (box 434).

In one or more embodiments of the present invention, as illustrated in FIG. 5D, the programming device may configure a number of ECU devices or lighting products in parallel so as to minimize programming time. In one or more embodiments, a plurality of ECU devices may be programmed serially, i.e., sequentially. In doing so, advantageously, each of the plurality of ECU devices need not be separated and all operations needed for the programming can be automated. In alternative embodiments, a plurality of ECU devices may be programmed in parallel (simultaneously) as illustrated in FIG. 5D. Even when the units are programmed sequentially, it appears to be programmed in parallel as all preceding and succeeding operations can be performed before and after programming all the plurality of ECU devices. For example, the ECU device manufacturer may configure. For example, the brightness of the lamps in one lot to a first brightness while configuring the brightness of the lamps in another lot differently. Similarly, in another example, the ECU device manufacturer may configure a first batch of ECU devices 20 to have a first color temperature while configuring another batch of ECU devices 20 with a different second color temperature. In various embodiments, the ECU device manufacturer may also configure one or more of other parameters such as relating to operating current, operating voltage, recordation of operating conditions such as error conditions, debugging data; operating criterion including operating hours, operating life time; geographic data; user authorization data; user preferences; and others.

The information stored in the wireless interface circuit 10 is retrieved by the ECU device 20 during an initial set-up by the user. In one illustration, the user of the device powers up the device, and the parameters are automatically retrieved and loaded.

In some embodiments, the end user may also write into the wireless interface circuit 10 using a wireless control device 100 so that the operation of the lamp 30 may be configured during product use.

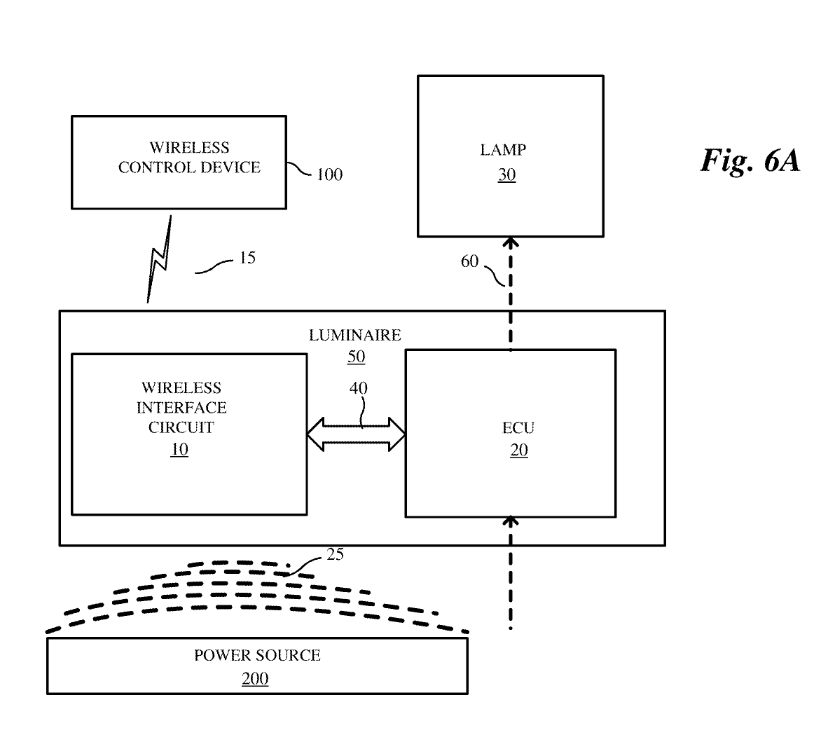

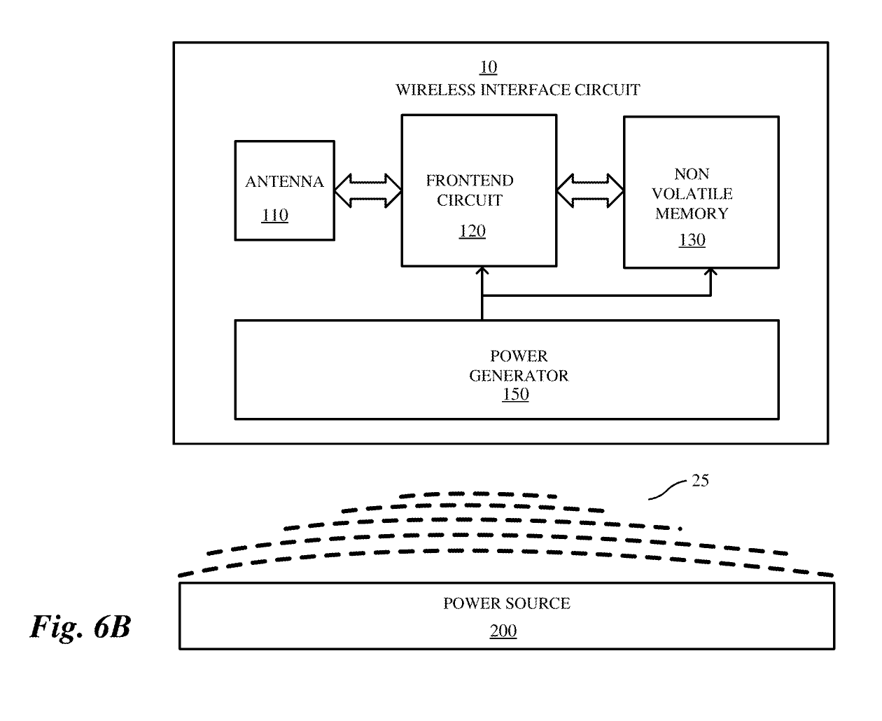

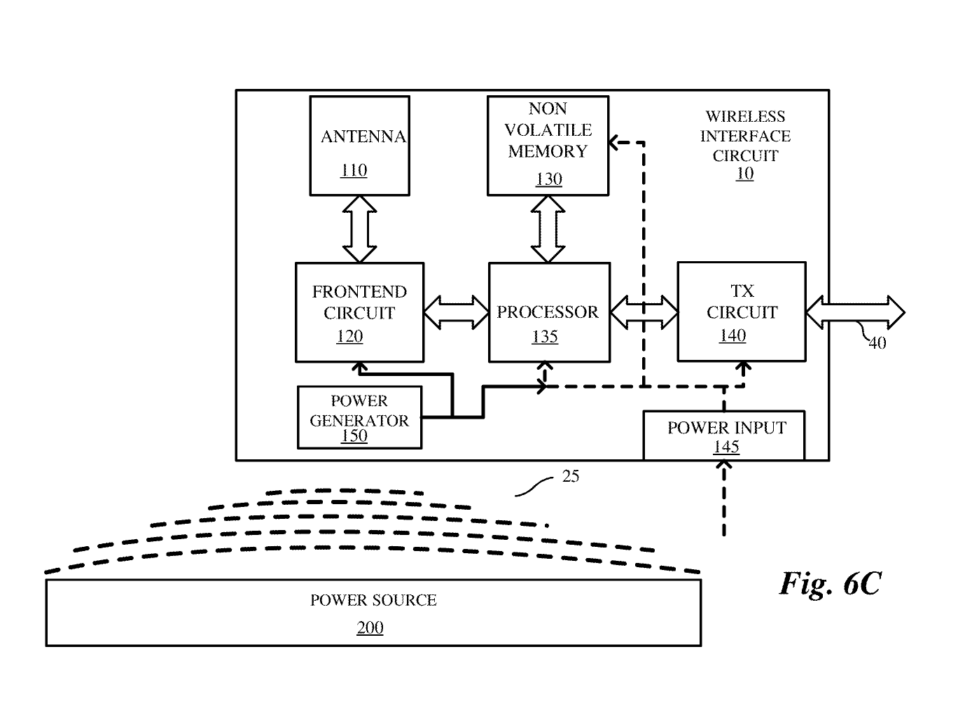

FIGS. 6A-6C illustrate a luminaire unit in accordance with an alternative embodiment of the present invention. FIG. 6A illustrate a schematic of the luminaire unit while FIGS. 6B and 6C illustrate alternative embodiments of the wireless interface circuit.

In the embodiment of FIGS. 6A-6C, an alternative power source may be used to power the wireless interface circuit 10 during the transfer of information from the wireless control device 100.

Referring to FIG. 6A, a power source 200 is disposed near the luminaire 50 so as to apply an electromagnetic field 25 near the wireless interface circuit 10. In one or more embodiments, the power may be transmitted using inductive coupling including resonant inductive coupling.

Referring to FIG. 6B, in one or more embodiments, the wireless interface circuit 10 may include a power generator 150, which may include a separate antenna, for example, inductively coupled with the power source 200. The power generator 150 outputs power to the frontend circuit 120 and the non-volatile memory 130. In one or more embodiments, the power output from the power generator 150 may be DC voltage less than 5V, for example.

In various embodiments, the power generator 150 requires no physical or wired electrical connection to an external power source. In other words, in various embodiments, the power generator 150 is configured to produce power without a wired connection. In one or more embodiments, the power generator 150 may generate an inductive coupling, optical, mechanical effects to generate power. For example, in one embodiment, the power generator 150 may include one or more coils, which may be configured to generate a current, when another external coil carrying current is brought nearby due to induction. Embodiments of the power generator 150 may work on the principles of direct induction, resonant magnetic induction, and others. In other embodiments, the power generator 150 may use lasers and other types of electromagnetic waves.

Alternatively, in another embodiment, the power generator 150 may include a piezoelectric crystal and rely on piezoelectric effect for generating power. In yet another embodiment, the power generator 150 may generate power using an optical technology such as solar cell technology relying on photoelectric effect.

In yet another embodiment, the power generator 150 may include a mechanism to convert kinetic energy to power, for example, by the motion of a magnet in an electric generator. In a further embodiment, the power generator 150 may include a mechanism to convert the ambient heat into electric power, for example, by using thermoelectric generators.

FIG. 6C illustrates a wireless interface circuit in accordance with another alternative embodiment of the present invention.

Power to the wireless interface circuit 10 may be supplied using a different protocol than the protocol for transferring information or parameters relating to the operation of the lamp 30. This may be enabled because of the separation in the circuit for generating power from the circuit for communication. Further, because higher power levels may be generated at the power generator 150, which may facilitate the use of more power intensive protocols for transfer for information or parameters relating to the operation of the lamp 30 to the wireless interface circuit 10. The additional power may be used to communicate with more complex protocols. Accordingly, the wireless interface circuit 10 may also include a dedicated processor 135 in one or more embodiments.

Consequently, embodiments of the present invention may use a combination of different protocols, for example, a wireless charging technology such as based on induction charging for powering the wireless interface circuit 10 may be combined with Bluetooth and/or Bluetooth low energy technology for communication. Alternatively, the wireless charging technology for powering the wireless interface circuit 10 may be combined with WiFi technology (e.g., 802.11) for communication. In another embodiment, the wireless charging technology for powering the wireless interface circuit 10 may be combined with RFID technology for communication. In another embodiment, the wireless charging technology for powering the wireless interface circuit 10 may be combined with low power communication technologies such as Wireless USB, IEEE 802.15, ZigBee, Radio Frequency for Consumer Electronics (RF4CE), ultra-wide band (e.g., >500 MHz), 6LoWPAN (IPv6 over Low power Wireless Personal Area Networks), ANT protocol, and others.

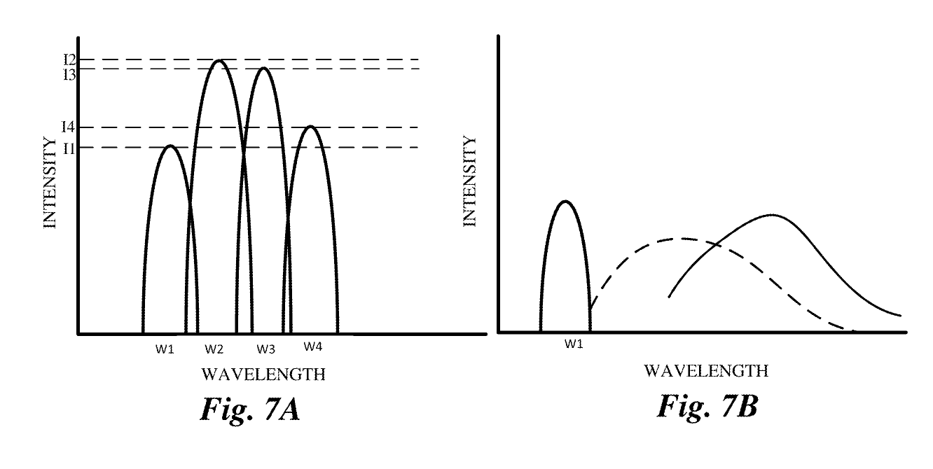

FIGS. 7A and 7B illustrate an embodiment of the present invention for configuring the operation of a LED.

FIG. 7A illustrates a lamp comprising a plurality of LEDs operating at multiple output wavelengths (i.e., colors or CCT). In one or more embodiments, the drive current of each of the LEDs might be individually controlled by the wirelessly configured parameter as described previously in various embodiments. Accordingly, the light output from the lamp may be tailored for individual application. As an illustration, a colored light output may be generated by mixing different wave lengths (colors) or the color temperature (CCT) of the light may be adjusted by mixing individual intensity light from two or more different light sources.

In the illustration of FIG. 7A, four LED having light output at a first wavelength W1, a second wavelength W2, a third wavelength W3, and a fourth wavelength W4 are illustrated. Changing the current supplied to a particular LED changes the intensity for that particular LED. In the illustration, a first current supplied to the first LED operating at the first wavelength W1 produces light at a first intensity I1. Similarly, a second current supplied to the second LED operating at the second wavelength W2 produces light at a second intensity I2, a third current supplied to the third LED operating at the third wavelength W3 produces light at a third intensity I3, and a fourth current supplied to the fourth LED operating at the fourth wavelength W4 produces light at a fourth intensity I4. Thus, total light output from the lamp, which is a sum of each of the individual light output may be changed by changing the supply current.

FIG. 7B illustrates another embodiment in which one or more LED devices has a phosphor coating resulting in dual emission (dashed line of the LED shows a first peak defined by the diode's characteristic and a second emission due to luminance from the phosphor coating). When more than one type of phosphor having different luminance is coated, multiple phosphor curves may be generated. These multiple phosphor curves may be combined to tailor the color and/or brightness of the light output.

For illustration, in FIG. 7B, a LED having an output wavelength (W1) is shown along with output from two different types of phosphor coatings. These phosphor coatings may be applied on different LEDs in various embodiments. As can be visualized, the total light output is a summation of the individual light intensity from the LEDs and the phosphor coatings.

Specifically, in one example embodiment, a first LED having an output at wavelength W1 and coated with a first type of phosphor coating and a second LED having an output at wavelength W1 and coated with a second type of phosphor coating. The total light output is a summation of the intensity from both LEDs at wavelength W1 (sum illustrated by the thick solid line), the dashed line from a first phosphor coating, and the solid line from a second phosphor coating. By varying the drive current being supplied to each of the LEDs, the intensity of light output from the phosphor coatings may be relatively changed. Accordingly, using embodiments of the present invention, the feel of the light output from the lamp may be modulated by the lamp manufacturer or the end customer.

In various embodiments, the lamp comprising the LEDs (or other electronic product manufactured according to the embodiments described herein) may be designed in anticipation of subsequent programming using embodiments of the present invention. For example, anticipating that the color of the light output may be changed, a LED lamp may include three types of blue LEDs—a first blue LED having no phosphor coating, a second blue LED having a first type of phosphor coating, and a third blue LED having a second different type of phosphor coating. Thus, when the color parameter is wirelessly programmed as described in various embodiments, during subsequent operation, the drive current provided to each of the blue LED may be relatively varied to provide a color output profile as defined in the new parameter.

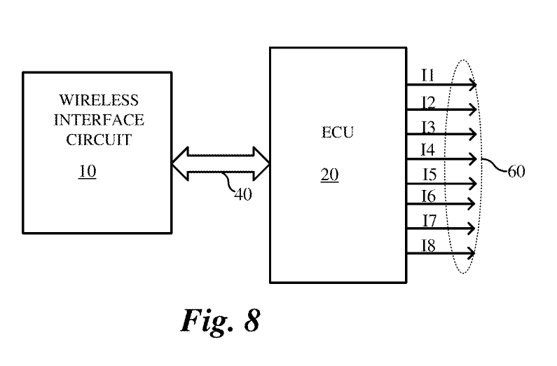

FIG. 8 illustrates an ECU device outputting multiple currents in accordance with embodiments of the present invention. The wireless interface circuit 10 receives the parameters from a wireless control device. Subsequently during operation of the LED, the ECU device 20 retrieves this information and uses it to control the relative current outputs, for example, 11-18 provided to the LEDs. For example, FIG. 8 may be applied to the lamp comprising a plurality of LEDs illustrated in FIGS. 7A and 7B.

The lighting products and light emitting diodes described above may be used in various applications. For example, they may be part of light generating component of a TV, computer screen, a tablet screen, a smart phone screen, cameras as well as different types of lamps or luminaires.

Embodiments of the present invention are not limited to any particular type of lighting. Further, embodiments of the present invention may be applied to other electronic products and are not limited only to lighting products.

Accordingly, in various embodiments, an electronic product line is developed. Advantageously, a plurality of identical electronic products are fabricated and stocked by the manufacturer. Each of the plurality of identical electronic products has similar input/output characteristics. This is because each of the plurality of identical electronic products is preconfigured to operate similarly, i.e., built with same default parameters. In one illustration, the electronic products are programmed before being supplied to customers with a different set of parameters thereby producing products having different input/output characteristics. For example, after receiving a customer order, a plurality of electronic products having a second characteristic different from the preconfigured first characteristic is configured wirelessly. Thereby, the programmed electronic product is configured to operate with the second characteristic that is different from the first characteristic of the default parameters, during product operation.

After such programming, the subset of electronic products (a first set of the plurality of identical electronic products) may be shipped to the user end or a supplier store (a second location remote from the first location).

In further embodiments, a request to supply electronic products having a third characteristic different from the preconfigured first characteristic and the second characteristic is received. A second set of the plurality of identical electronic products is wirelessly configured to generate a second plurality of electronic products having the third characteristic, where each of the second plurality of electronic products is configured to operate with the third characteristic during operation. The second plurality of electronic products with the third characteristic may be shipped to a third location remote from the first location.

In one illustrative embodiment, the electronic product line comprises a luminaire product line. In one embodiment, each of the plurality of identical electronic products comprises light emitting diodes. In alternative embodiments, the electronic product line comprises chargers, adapter, and power supplies. Each of the plurality of identical electronic products comprises chargers, adapter, or power supplies. For example, the manufacturer may produce a product line for power supply units. However, each specific product in the power supply product line may have different operating characteristics such as output voltages or output current. A particular product may be therefore created by the wireless configuration methods described in various embodiments.

One general aspect includes a driver for a lighting product, the driver including a wireless interface circuit configured to be accessed wirelessly to store information relating to operation of the lighting product. A driving circuit is coupled to the wireless interface circuit, the driving circuit is configured to retrieve the stored information relating to the operation of the lighting product from the wireless interface circuit and drive the lighting product based on the retrieved information.

Implementations of the drive may include one or more of the following features. The driver further including a radio frequency (RF) antenna configured to receive RF signals including the information relating to the operation of the lighting product. A RF front end is configured to process the RF signals received at the antenna and retrieve the information relating to the operation of the lighting product. A non-volatile memory is configured to store the information relating to the operation of the lighting product. A power generator is configured to generate power wirelessly and provide power supply to the RF front end and the non-volatile memory. In another implementation, the information relating to the operation of the lighting product includes drive current.

In one or more implementation, the driver further includes a protection circuit in the driving circuit, where the information relating to the operation of the lighting product activates the protection circuit, or deactivates the protection circuit, or configures the protection circuit. The protection circuit includes an over-current protection circuit, over-voltage protection circuit, over-temperature protection circuit, under-current protection circuit, or under-voltage protection circuit. The driver may further include an external device coupled to the driving circuit, where the information relating to the operation of the lighting product configures the external device. The external device includes a transformer, capacitor, and/or inductor. The information relating to the operation of the lighting product includes one or more of color temperature and luminosity information. The driver where the lighting product includes a plurality of LEDs, where the information relating to operation of the lighting product includes information for each of the plurality of LEDs. The driver where the wireless interface circuit is configured to be compliant with a near field communication protocol or a radio frequency identification protocol. The driver where the wireless interface circuit further includes a power generator configured to generate power wirelessly and provide power supply to the wireless interface circuit. The driver where the power generator is powered by an electromagnetic field used to access the wireless interface circuit. The driver where wireless interface circuit is compliant with at least one selected from the group consisting of Bluetooth low energy, IEEE 802.15, ZigBee, Radio Frequency for Consumer Electronics, ANT protocol, ultra-wide band, and 6LoWPAN (IPv6 over Low power Wireless Personal Area Networks). The wireless interface circuit of the driver is configured to be accessed by electromagnetic waves, and where the power generator is configured to be powered by an energy source different from the electromagnetic waves. The driver where the electromagnetic waves are compliant with at least one selected from the group consisting of Bluetooth, Wireless USB, Bluetooth low energy, IEEE 802.15, ZigBee, Radio Frequency for Consumer Electronics, ANT protocol, ultra-wide band, and 6LoWPAN (IPv6 over Low power Wireless Personal Area Networks), and where the power generator is configured to receive power from the energy source using inductive charging, photoelectric process using a photo cell, mechanical movement, piezoelectric process, or thermoelectric power generation.

Another general aspect includes a method of configuring an electronic controller (EC). The method includes wirelessly receiving signals comprising information relating to operation of an EC from a wireless control device to a wireless interface circuit and processing the wireless signals to retrieve the information relating to the operation of the EC. The information relating to the operation of the EC is stored at the wireless interface circuit.

Implementations may include one or more of the following features. The method where the information relating to the operation of the EC includes drive current for a light emitting diode. The method further including: activating or deactivating one or more protection circuits in the EC based on the information relating to the operation of the EC or configuring a protection circuit in the EC based on the information relating to the operation of the EC. The method where the protection circuit is configured to provide protection against one or more of over-current, over-voltage, over-temperature, under-current, and under-voltage. The method further including: configuring an external device coupled to the EC based on the information relating to the operation of the EC. The method where the external device includes a transformer, capacitor, and/or inductor. The method where the information relating to the operation of the EC includes one or more of color temperature and luminosity information. The method further including: powering the EC configured to operate a lighting product including one or more connected light emitting diodes (LED); retrieving the stored information relating to the operation of the EC from the wireless interface circuit; and using the information relating to the operation of the EC to modify the operation of the EC. The method further including: wirelessly receiving power needed to process the received wireless signals and store the information. The method where the wireless signals and the power are received from a same source. The method where the wireless signals are compliant with at least one selected from the group including Bluetooth low energy, IEEE 802.15, ZigBee, Radio Frequency for Consumer Electronics, ANT protocol, ultra-wide band, and 6LoWPAN (IPv6 over Low power Wireless Personal Area Networks). The method where the wireless signals and the power are received from different sources. The method where the wireless signals are compliant with at least one selected from the group including Bluetooth low energy, IEEE 802.15, ZigBee, Radio Frequency for Consumer Electronics, ANT protocol, ultra-wide band, and 6LoWPAN (IPv6 over Low power Wireless Personal Area Networks), where the power is received using inductive charging, photoelectric process using a photo cell, mechanical movement, piezoelectric process, or thermoelectric charging.

The method may further include shipping the plurality of electronic products with the second characteristic to a second location remote from the first location. The method may further include: receiving a request to supply electronic products having a third characteristic different from the preconfigured first characteristic and the second characteristic; and at the first location, wirelessly configuring a second set of the plurality of identical electronic products to generate a second plurality of electronic products having the third characteristic, where each of the second plurality of electronic products is configured to operate with the third characteristic during operation. The method may further include shipping the second plurality of electronic products with the third characteristic to a third location remote from the first location. The method where the wirelessly configuring may include: wirelessly receiving wireless signals including information relating to the first characteristic from a wireless control device to a wireless interface circuit in each of the plurality of identical electronic products; processing the wireless signals to retrieve the information relating to the first characteristic; and storing the information relating to the first characteristic at the wireless interface circuit. The method may further include: wirelessly receiving power needed to process the received wireless signals and store the information. The method where the electronic product line includes a lighting product line. The method where each of the plurality of identical electronic products includes light emitting diodes. The method where the electronic product line includes chargers, adapter, and power supplies. The method where each of the plurality of identical electronic products includes chargers, adapter, or power supplies.

Another general aspect includes a method of manufacturing an electronic product line, the method including: packaging a plurality of semiconductor devices to form a plurality of identical electronic products. Each of the plurality of identical electronic products is configured to have similar input/output characteristic such that each of the plurality of identical electronic products is configured to operate with a first characteristic; and at a first location, wirelessly configuring a first set of the plurality of identical electronic products to generate a plurality of electronic products having a second characteristic different from the preconfigured first characteristic, where each of the plurality of electronic products is configured to operate with the second characteristic during operation.

Implementations may include one or more of the following features. The method further including shipping the plurality of electronic products with the second characteristic to a second location remote from the first location. The method may further include: receiving a request to supply electronic products having a third characteristic different from the preconfigured first characteristic and the second characteristic; and at the first location, wirelessly configuring a second set of the plurality of identical electronic products to generate a second plurality of electronic products having the third characteristic, where each of the second plurality of electronic products is configured to operate with the third characteristic during operation. The method may further include shipping the second plurality of electronic products with the third characteristic to a third location remote from the first location. The method where the wirelessly configuring includes: wirelessly receiving wireless signals including information relating to the first characteristic from a wireless control device to a wireless interface circuit in each of the plurality of identical electronic products; processing the wireless signals to retrieve the information relating to the first characteristic; and storing the information relating to the first characteristic at the wireless interface circuit. The method may further include: wirelessly receiving power needed to process the received wireless signals and store the information. The method where the electronic product line includes a lighting product line. The method where each of the plurality of identical electronic products includes light emitting diodes. The method where the electronic product line includes chargers, adapter, and power supplies. The method where each of the plurality of identical electronic products includes chargers, adapter, or power supplies.

While this invention has been described with reference to illustrative embodiments, this description is not intended to be construed in a limiting sense. For example, although described above in specific embodiments with respect to lighting products, embodiments of the present invention may be applied to any electronic product, which is packaged, and is configured subsequently. Various modifications and combinations of the illustrative embodiments, as well as other embodiments of the invention, will be apparent to persons skilled in the art upon reference to the description. It is therefore intended that the appended claims encompass any such modifications or embodiments.

What is claimed is:

1. A driver for a lighting product, the driver comprising:
a wireless interface circuit configured to be accessed wirelessly to store information relating to operation of the lighting product; and
a driving circuit coupled to the wireless interface circuit, the driving circuit configured to retrieve the stored information relating to the operation of the lighting product from the wireless interface circuit and drive the lighting product based on the retrieved information.

2. The driver of claim 1, further comprising:
a radio frequency (RF) antenna configured to receive RF signals comprising the information relating to the operation of the lighting product;
a RF front end configured to process the RF signals received at the antenna and retrieve the information relating to the operation of the lighting product;
a non-volatile memory configured to store the information relating to the operation of the lighting product; and
a power generator configured to generate power wirelessly and provide power supply to the RF front end and the non-volatile memory.

3. The driver of claim 1, wherein the information relating to the operation of the lighting product comprises drive current.

4. The driver of claim 1, further comprising:
a protection circuit in the driving circuit, wherein the information relating to the operation of the lighting product activates the protection circuit, or deactivates the protection circuit, or configures the protection circuit.

5. The driver of claim 4, wherein the protection circuit comprises an over-current protection circuit, over-voltage protection circuit, over-temperature protection circuit, under-current protection circuit, or under-voltage protection circuit.

6. The driver of claim 1, further comprising:
an external device coupled to the driving circuit, wherein the information relating to the operation of the lighting product configures the external device.

7. The driver of claim 6, wherein the external device comprises a transformer, capacitor, and/or inductor.

8. The driver of claim 1, wherein the information relating to the operation of the lighting product comprises one or more of color temperature and luminosity information.

9. The driver of claim 1, wherein the lighting product comprises a plurality of LEDs, wherein the information relating to operation of the lighting product comprises information for each of the plurality of LEDs.

10. The driver of claim 1, wherein the wireless interface circuit is configured to be compliant with a near field communication protocol or a radio frequency identification protocol.

11. The driver of claim 1, wherein the wireless interface circuit further comprises a power generator configured to generate power wirelessly and provide power supply to the wireless interface circuit.

12. The driver of claim 11, wherein the power generator is powered by an electromagnetic field used to access the wireless interface circuit.

13. The driver of claim 12, wherein wireless interface circuit is compliant with at least one selected from the group consisting of Bluetooth low energy, IEEE 802.15, ZigBee, Radio Frequency for Consumer Electronics, ANT protocol, ultra-wide band, and 6LoWPAN (IPv6 over Low power Wireless Personal Area Networks).

14. The driver of claim 11, wherein the wireless interface circuit is configured to be accessed by electromagnetic waves, and wherein the power generator is configured to be powered by an energy source different from the electromagnetic waves.

15. The driver of claim 14, wherein the electromagnetic waves are compliant with at least one selected from the group consisting of Bluetooth, Wireless USB, Bluetooth low energy, IEEE 802.15, ZigBee, Radio Frequency for Consumer Electronics, ANT protocol, ultra-wide band, and 6LoWPAN (IPv6 over Low power Wireless Personal Area Networks), and wherein the power generator is configured to receive power from the energy source using inductive charging, photoelectric process using a photo cell, mechanical movement, piezoelectric process, or thermoelectric power generation.

16. A method of configuring an electronic controller (EC), the method comprising:
wirelessly receiving signals comprising information relating to operation of an EC from a wireless control device to a wireless interface circuit;
processing the wireless signals to retrieve the information relating to the operation of the EC; and
storing the information relating to the operation of the EC at the wireless interface circuit.

17. The method of claim 16, wherein the information relating to the operation of the EC comprises drive current for a light emitting diode.

18. The method of claim 16, further comprising:
activating or deactivating one or more protection circuits in the EC based on the information relating to the operation of the EC or configuring a protection circuit in the EC based on the information relating to the operation of the EC.

19. The method of claim 18, wherein the protection circuit is configured to provide protection against one or more of over-current, over-voltage, over-temperature, under-current, and under-voltage.

20. The method of claim 16, further comprising:
configuring an external device coupled to the EC based on the information relating to the operation of the EC.

21. The method of claim 20, wherein the external device comprises a transformer, capacitor, and/or inductor.

22. The method of claim 16, wherein the information relating to the operation of the EC comprises one or more of color temperature and luminosity information.

23. The method of claim 16, further comprising:
powering the EC configured to operate a lighting product comprising one or more connected light emitting diodes (LED);
retrieving the stored information relating to the operation of the EC from the wireless interface circuit; and
using the information relating to the operation of the EC to modify the operation of the EC.

24. The method of claim 16, further comprising:
wirelessly receiving power needed to process the received wireless signals and store the information.

25. The method of claim 24, wherein the wireless signals and the power are received from a same source.

26. The method of claim 25, wherein the wireless signals are compliant with at least one selected from the group consisting of Bluetooth low energy, IEEE 802.15, ZigBee, Radio Frequency for Consumer Electronics, ANT protocol, ultra-wide band, and 6LoWPAN (IPv6 over Low power Wireless Personal Area Networks).

27. The method of claim 24, wherein the wireless signals and the power are received from different sources.

28. The method of claim 27, wherein the wireless signals are compliant with at least one selected from the group comprising Bluetooth, Wireless USB, Bluetooth low energy, IEEE 802.15, ZigBee, Radio Frequency for Consumer Electronics, ANT protocol, ultra-wide band, and 6LoWPAN (IPv6 over Low power Wireless Personal Area Networks), wherein the power is received using inductive charging, photoelectric process using a photo cell, mechanical movement, piezoelectric process, or thermoelectric charging.

29. A method of manufacturing an electronic product line, the method comprising:
packaging a plurality of semiconductor devices to form a plurality of identical electronic products, wherein each of the plurality of identical electronic products is configured to have similar input/output characteristic such that each of the plurality of identical electronic products is configured to operate with a first characteristic; and
at a first location, wirelessly configuring a first set of the plurality of identical electronic products to generate a plurality of electronic products having a second characteristic different from the preconfigured first characteristic, wherein each of the plurality of electronic products is configured to operate with the second characteristic during operation.

30. The method of claim 29, further comprising shipping the plurality of electronic products with the second characteristic to a second location remote from the first location.

31. The method of claim 29, further comprising:
receiving a request to supply electronic products having a third characteristic different from the preconfigured first characteristic and the second characteristic; and
at the first location, wirelessly configuring a second set of the plurality of identical electronic products to generate a second plurality of electronic products having the third characteristic, wherein each of the second plurality of electronic products is configured to operate with the third characteristic during operation.

32. The method of claim 31, further comprising shipping the second plurality of electronic products with the third characteristic to a third location remote from the first location.

33. The method of claim 29, wherein the wirelessly configuring comprises:
wirelessly receiving wireless signals comprising information relating to the first characteristic from a wireless control device to a wireless interface circuit in each of the plurality of identical electronic products;
processing the wireless signals to retrieve the information relating to the first characteristic; and
storing the information relating to the first characteristic at the wireless interface circuit.

34. The method of claim 33, further comprising:
wirelessly receiving power needed to process the received wireless signals and store the information.

35. The method of claim 29, wherein the electronic product line comprises a lighting product line.

36. The method of claim 35, wherein each of the plurality of identical electronic products comprises light emitting diodes.

37. The method of claim 29, wherein the electronic product line comprises chargers, adapter, and power supplies.

38. The method of claim 37, wherein each of the plurality of identical electronic products comprises chargers, adapter, or power supplies.
